(19) United States
(12) Patent Application Publication
(10) Pub. No.: US 2006/0075414 A1
(43) Pub. Date: Apr. 6, 2006

(54) Packaging methodology for adding functionality to a data storage device (disk drive, tape drive, other storage device, or storage subsystem) while maintaining the same form factor, standard size, or allocated size; or by increasing the overall package size to a larger form factor, standard size, or allocated size

(75) Inventors: Robert James Rapp, San Jose, CA (US); Andrew David Hospodor, Los Gatos, CA (US)

Correspondence Address: ROBERT JAMES RAPP, 1120 RANCHERO WAY #10, SAN JOSE, CA, 95117, US

(73) Assignees: Robert J. Rapp; Andrew D. Hospodor

(21) Appl. No.: 11/242,192

(22) Filed: Oct. 3, 2005

Related U.S. Application Data
(60) Provisional application No. 60/616,283, filed on Oct. 6, 2004.

(51) Int. Cl. G11B 33/02; G11B 5/012; G11B 17/00; G11B 17/04; G11B 17/03

(52) U.S. Cl. 720/600; 360/97.01

(57) ABSTRACT

A packaging methodology for adding functionality to a data storage device (disk drive, tape drive, other storage device, or storage subsystem) while maintaining the same form factor, standard size, or allocated size; or by increasing the overall package size to a larger form factor, standard size, or allocated size. Different standard sizes of storage devices commonly referred to as form factors, the increase in storage densities, electronic miniaturization, smaller electronic assemblies performing the same/similar function, and modularized storage subsystems mean that additional functionality may be packaged within any given standard storage size (form factor): A storage device's function may be enhanced while maintaining the same volume (same length, width, height) or standard size (form factor) as was allocated for in the design of the storage device. Furthermore a smaller sized (form factor) storage device may be packaged with additional components into a space originally reserved for a larger sized form factor storage device. Since data security is of paramount importance today, the addition of data security functions within the form factor of any given data storage device is one compelling application of such a methodology, yet the scope of this invention is not limited to data security functions.

### CROSS REFERENCE TO RELATED APPLICATIONS

This application claims benefit from Provisional Patent Application # 60/616,283 Filing Date Oct. 6, 2004 Confirmation # 4629, a Provisional Patent for which this application is a non-provisional Utility Patent follow up by the same inventors: Robert James Rapp, & Andrew David Hospodor.

### FEDERAL RESEARCH STATEMENT

Not Applicable:

### BACKGROUND OF THE INVENTION

Converging factors such as the continued miniaturization of storage devices into smaller standardized sizes (form factors), growing concerns over the security of confidential data, the advent of inexpensive wireless technology, the evolution of storage device interfaces have enabled the possibility to package storage devices in a variety of new shapes and sizes.

Disk drives come in various standard sizes called form factors. In 2004, the standard form factors include 3.5, 2.5, 1.8 and 1 inch disk drives. Older/obsolete form factors include 14, 10.5, 8 and 5.25 inch disk drives. Future disk drives will likely include 0.8 inch or 0.85 inch form factors. The dimensions of each respective form factor are specified by industry standards. External dimensions, mounting screw size, and the placement of mounting holes are specified.

Furthermore, as disk drive density (capacity within the same form factor) doubles every 12-18 months, a smaller form factor disk drive will have capacity similar to a larger form factor disk drive within a year. Thus, for customers who wish to upgrade older systems with smaller form factor disks coupled with added functionality would not experience any reduction in overall storage capacity.

Disk drive electronics are shrinking with each subsequent generation of device. In fact today the size of a printed circuit board is ½ the size they were just a few years ago. A circuit board on a 3.5 inch form factor disk drive today covers less than ½ of the size of drive's footprint. This means that there is extra space available to package additional functionality into standard disk drives within 3.5 inch form factor. This extra space is simply not used prior to the advent of this invention.

Disk drives are sometimes made with different numbers of disk (1, 2, 3, or more disks). Sometimes a particular family of disk drives may have the same length and width, yet a different height. In such a case more space will be available for expanding functionality of the storage device as compared to a disk drive with the same length and width, yet a different height.

Disk drives are mounted in various configurations within systems, some are easy to remove, some maybe hot-plugged, where others are very difficult to remove.

Adding functionality to disk drives provides other benefits as well, entire embedded computers, or devices may be packaged onto the drive or into the resultant form factor providing a plurality of additional functions.

Modular storage subsystems, such as Blade Servers, have storage devices mounted on circuit boards or within modular assemblies that can be removed from the system as a unit. Here also additional functionality may be added into each modular unit that extends its functionality beyond the original design. Furthermore one or more modules could be cascaded such that several modular units may be removed at once and contain functionality beyond the original design.

Data security is one potential added function, preventing data from falling into “the wrong hands” is extremely important today. Data is more available and more portable than it has ever been. Vast amounts of critical data are stored every day on small data storage devices. NOTE: most often the storage device is a disk drive they are the most prevalent form of data storage. The loss or theft of a single computer or single disk drive represents an enormous threat to data security.

Considering all of this, benefits may be obtained through packaging a smaller form factor storage device (disk drive, or other form of computer storage device) with other components that add functionality into a package that is the size of a larger form factor disk drive. Furthermore, benefits may also be obtained by packaging these added components onto the drive while maintaining the same form factor by using this extra space.

### DESCRIPTION & SUMMARY OF THE INVENTION

Different storage standard sizes (form factors), the increase in storage densities, electronic miniaturization, smaller electronic assemblies performing the same/similar function, and modularized storage subsystems provide an opportunity to provide additional functionality through creative/advanced packaging.

A storage device's function may be enhanced while maintaining the same volume (same length, width, height) or standard size (form factor) as was allocated for in the design of the storage device.

Furthermore a storage device such as a disk drive packaged with other components that add functionality or extra storage such that the new package size is the size of a larger standard size (form factor) disk drive. The same is true for modular storage subsystems (like a Blade Server), and other storage devices.

Therefore: A storage device (such as a disk drive) packaged with other components that add functionality, extra storage, or convert the drives system interface, such that the new package size is the size of a storage device of another standard physical size (form factor) is one new packaging method. Another new packaging method is to provide additional functionality in space that is no longer used in a given form factor because of electronic miniaturization, thus additional function may be added while maintaining the same physical size (form factor).

Modular storage subsystems like Blade Servers have storage devices mounted on circuit boards or within modular assemblies that can be removed from the system as a unit. Here also additional functionality may be added into each modular unit that extends its functionality beyond the original design. Furthermore one or more modules could be cascaded such that several modular units may be connected and contain functionality beyond the original design.

This is a packaging methodology is in regard to added functionality packaged within a storage devices existing space constraints no matter what the added functionality is (data security, embedded GPS, embedded location finding, embedded communication/cell phone/text messaging, interface translation, storage concatenation/expansion, redundancy, electronic/mechanical, or a plurality of other functions). Integrating data security functions into the form factor of any given storage device is a key attribute of this invention.

For example disk drive electronics are shrinking with each subsequent generation of device. In fact today the size of a printed circuit board is ½ the size they were just a few years ago. A circuit board on a 3.5 inch form factor disk drive today covers less than ½ of the size of drive's footprint. This means that there is extra space available to package additional functionality into standard disk drives within 3.5 inch form factor. This extra space is simply not used prior to the advent of this invention. This extra space is empty & available real estate that may be use for adding a variety of additional functionality.

Other examples include: a 1.8 inch disk drive may be packaged with other components into the form factor of a 2.5 inch disk drive: a FLASH PC card may be built with GPS tracking, cell phone communication, & tamper detection functionality.

### BRIEF DESCRIPTION OF DRAWINGS

FIG. 1 shows a smaller form factor storage device (5) packaged with other components (6, 7, & 8) into the form factor of a larger storage device (4A, & 4B). Dimensions of the larger storage device are shown Length (1), Width (2), and Height (3). Top (4A) and side (4B) views are shown. A smaller form factor storage unit fits into the larger form factor with space for extra components.

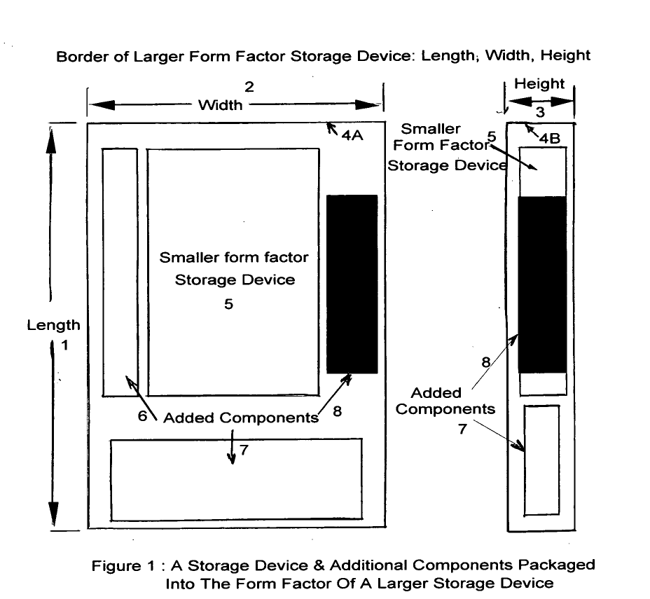

FIG. 2 shows a storage device (10A, 10B, & 10C), the device's circuit board (9), and added components (11, & 12). Top (10A), side (10B), and edge (10C) views are shown. Additional components fit into the space not occupied by current electronics. For example today standard electronics for a 3.5 inch disk drive cover only ½ of the surface of the drive, where in the recent past these electronics took up the entire surface.

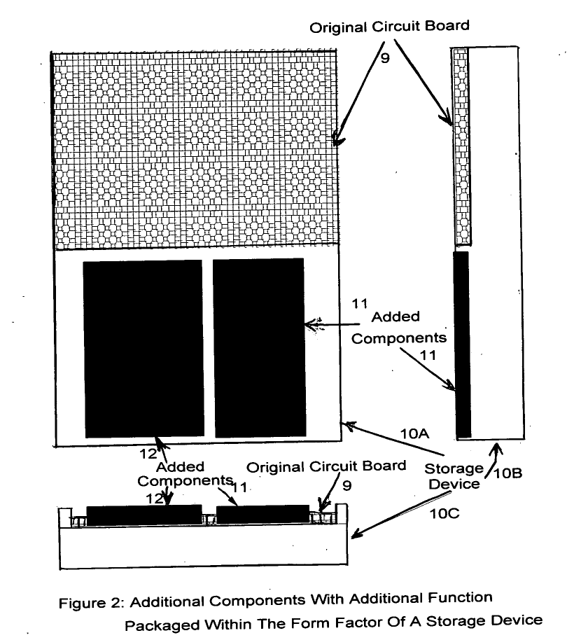

FIG. 3 shows two storage units/storage subsystems packaged together (11, 12). Additional functionality is integrated into modules while maintaining inter-module spacing.

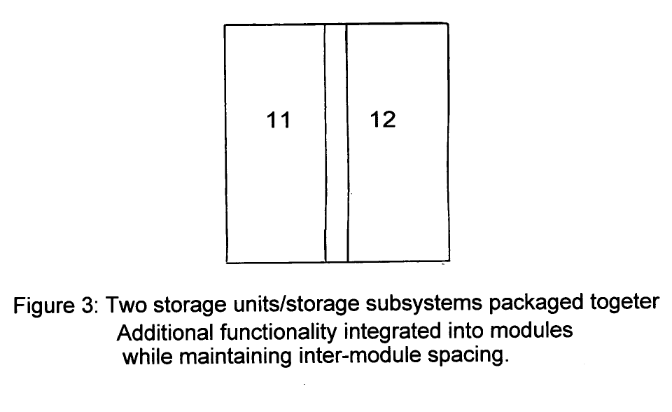

FIG. 4 shows five storage units/storage subsystems packaged together (12, 13, 14, 15, & 16). Additional functionality integrated into modules while maintaining inter-module spacing.

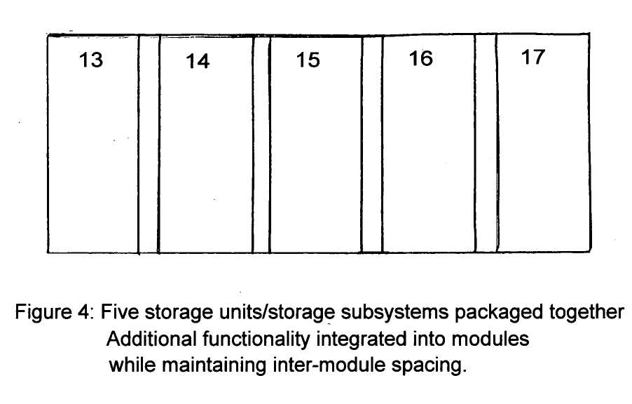

1. A data storage device where the package size corresponds to a standard form factor size; length, width, height, or allocated volume.

2. Claim 1 with additional components such that the overall package size still fits within the storage device's original standard form factor size; length, width, or allocated volume.

3. Claim 1 with additional components such that the overall package size corresponds to a larger standard form factor size; length, width, or allocated volume.

4. Claim 1 where the data storage device is a rotating magnetic storage device.

5. Claim 1 where the data storage device is a semiconductor data storage device.

6. Claim 1 where the data storage device is an optical data storage device.

7. Claim 1 where the data storage device is a modular storage subsystem consisting of one or a plurality of data storage devices.

8. Claim 1 with additional components that convert the data storage device's electrical communication interface to another type of computer communication interface.

9. Claim 7 where the communication interface is wireless.

10. Claim 1 with additional components that provide a tracking functionality to locate the storage device.

11. Claim 1 with additional components that provide a data protection function that authenticates and limits access to the data to authorized users.

12. Claim 1 with additional components that initiate a data security function upon detection of the device being tampered with.

13. Claim 1 with additional components that initiate a data security function upon removal of the device from a system or subsystem.

14. Claim 1 with additional components that initiate a data security function upon movement of the device.

15. Claim 15 with additional components that include a canister that contains a substance solid, gas, or liquid.

16. Claim 15 where the substance, solid, gas, or liquid is intended to destroy the data on the disk.

17. Claim 15 where the substance, solid, gas, or liquid is intended to repair or recover data from the disk.

18. Claim 1 with additional components that include an energy storage device.

19. Claim 1 with additional components that include electronic components.

20. Claim 1 with additional components that include components intended to destroy electronic components.

21. Claim 1 with additional components that erase data stored in the data storage device.

22. Claim 9 where a data security function is initiated remotely through a wireless communication interface.
